(19) United States
(12) Patent Application Publication
(10) Pub. No.: US 2006/0199059 A1
(43) Pub. Date: Sep. 7, 2006

(54) Ion conductive polymer electrolyte and its membrane electrode assembly

(76) Inventor: Helen X. Xu, Sunnyvale, CA (US)

Correspondence Address: LEWIS, BRISBOIS, BISGAARD & SMITH LLP, 221 NORTH FIGUEROA STREET, SUITE 1200, LOS ANGELES, CA, 90012, US

(21) Appl. No.: 11/364,405

(22) Filed: Feb. 28, 2006

Related U.S. Application Data
(60) Provisional application No. 60/657,542, filed on Mar. 1, 2005.

(51) Int. Cl. H01M 8/10; C08J 5/20; B05D 5/12

(52) U.S. Cl. 429/30; 521/25; 427/115; 502/101

(57) ABSTRACT

A membrane electrode assembly comprising a solid proton conducting polymer membrane, an anode, a cathode, the anode and the cathode being on opposing surfaces of the membrane, and a catalyst layer in contact with each surface of the membrane, the assembly comprising a polymer electrolyte comprising a base polymer containing ionic conducting groups, said polymer having flexible and strong molecular chains, and rigid, conductive nanoparticles disbursed among the base polymer.

This application claims the benefit of U.S. Provisional Application Ser. No. 60/657,542 filed Mar. 1, 2005, which application is incorporated herein by reference in its entirety.

### FIELD OF THE INVENTION

The present invention relates to ion conductive polymer electrolyte compositions and their use in membrane electrode assemblies. These ion conductive polymers have particular application in Polymer-Electrolyte Membrane (PEM) fuel cells, as well as for electrochemical devices. More particularly, they can be used in direct methanol fuel cell (DMFC) applications.

### BACKGROUND OF THE INVENTION

A major limiting design factor for wireless devices is battery power. The on-going effort towards improvement of battery technology and smart circuit design cannot catch up with the increasing demands for device power consumption. This power crisis for portable devices urges the development of viable alternatives to overcome the deficiencies of rechargeable batteries. A micro DMFC can provide such a solution. The advantages of micro DMFCs over batteries are: (1) substantially more energy, (2) instant charging, (3) lighter weight and 4) easy package & distribution. This is why most major consumer electronic companies (such as Toshiba, Hitachi, Fujitsu, Samsung and NEC) have endorsed DMFC technology over others. However, there are obstacles in reducing fuel cell size to meet the form factor requirements of new wireless devices. The biggest challenges in reducing size has to do with low power density, low conductivity of membranes, methanol crossover, methanol concentration limitation, water leakage, and associated bulky Balance of Plant (BOP) parts and high auxiliary power.

Traditionally, a DMFC system consists of a fuel cell stack, a fuel cartridge and a balance of plant (BOP), which includes pumps and sensors and an electronic control system. Fuel cell stacks usually comprise membrane electrode assemblies (MEA), bipolar plates and end plates. The key component in the fuel cell is the membrane electrode assembly (MEA), which comprises a pair of electrodes attached to both sides of a polymer electrolyte membrane (PEM). Each electrode is mainly composed of catalyst and ionomer, in which the ionomer can be same material as the polymer electrolyte membrane or a different material. In fuel cell operations, methanol is supplied to one of the electrodes (anode) as fuel, where it is oxidized to produce electrons and hydrogen ions, that migrate through the polymer electrolyte membrane to the cathode. At the same time, oxygen gas or air is supplied to the other electrode (cathode) to combine hydrogen ions and electrons to produce electricity. The by-products of this reaction are carbon dioxide and water. To speed up the reaction and improve fuel cell performance, it is important to have oxygen (O₂) facilitating the pathway. Equally important is to quickly remove the by-products: water and carbon dioxide (CO₂).

Most DMFC products are based on membranes made from perflourinated polymers (e.g., Dupont's Nafion), which were originally designed for hydrogen fuel cells. These membranes are unable to prevent methanol leakage and water flooding issues.

Several attempts have been made, including modified Nafion with a filler such as inorganic material silica and phosphototungstic acid (PWA). U.S. Pat. No. 5,919,583 discloses a method of reducing crossover in a DMFC by dispersing zeolite and zirconium in the polymer electrolyte. However, while simple dispersion of inorganic particles in the polymer electrolyte membrane may be effective in preventing the methanol crossover, it reduces the proton conductivity as well. U.S. Patent Application No. 2002/0091225 discloses a method to incorporate a heteropoly acid, such as phosphototungstic acid (PWA) into a polymer electrolyte membrane, in an attempt to improve conductivity. However, the solubility of PWA in water is a problem, especially in the application of using methanol aqueous solution in a DMFC. U.S. Pat. No. 6,630,265 discloses a method of mixing an inorganic cation exchange material such as montmorillonite into an inert polymer binder matrix. The conductivity of this membrane is unsatisfactory.

Other attempts at improvement include utilizing non-fluorinate polymers. For example, U.S. Pat. No. 6,214,488 discloses a method of producing a polymer electrolyte membrane from sulfonated aromatic polyether ketone. U.S. Patent Applications No. 2003/0219640, No. 2004/012666, and No. 2004/0039148 discuss a method of producing sulfonated polyaryl ketone as a polymer electrolyte. However, most of these polymer membranes struggle due to swelling and methanol crossover with conductivity. With flexible polymer chains bearing more ionic conductive groups, the membranes' conductivity increases. But those membranes swell a great deal due to numerous water molecules associated with ionic charge groups, thus leading to high methanol crossover. Most prior art techniques attempted to restrict the polymer chain mobility via either crosslinking or less conductive groups to reduce membrane swelling and methanol crossover. This often resulted in low conductivity and low power. In addition, all of the prior art using non-fluorinated polymers as polymer electrolyte membranes, were still using Fluorinated Nafion ionomer in the electrode layer, thus causing an incompatibility problem, which often led to delamination of the MEA and degradation of cell performance. Furthermore, water by-product generated during operation often led to flooding the cathode, causing performance drop and a water leakage problem. This demanded a very complicated balance of plant (BOP) to ease the problem.

Therefore, there is a need for a good performance polymer electrolyte to maintain good conductivity, while eliminating methanol crossover and membrane swelling. In addition, it is desired to use a similar material in both membrane and electrode to improve the compatibility and durability of MEA. Furthermore, it is also desired to have an MEA with an internal water regulation mechanism to simplify the balance of plant (BOP) system.

### SUMMARY OF THE INVENTION

To solve the aforementioned problems, it is a first object of this invention to provide an ionic conductive material as a polymer electrolyte with excellent ionic conductivity, low methanol crossover and low membrane swelling.

One aspect of the present invention is directed to a composite ionic conductive material for use as a polymer electrolyte in fuel cells that include:
1. Base polymers containing ionic conducting groups, preferably base polymer having flexible, tough molecular chains (strong bonding), referred to as “flexible domain”. The density of the ionic conductive groups should be low to avoid excess swelling, preferably from 0 to 2.0 mmol./g, more preferably from 0 to 0.9 mmol./g.
2. Rigid, ionic, conductive nanoparticles, referred as “rigid domain”, are well dispersed among the base polymers (flexible domain) as described in (1) via physical and chemical bonds. The density of ionic charge groups may be in the range of from 0 to 20 mmol./g, preferably from 0.3 to 10 mmol./g, most preferably from 0.5 to 3.0 mmol./g.

The major function of the base polymer is to provide membrane formation characteristics, and physical strength (e.g., flexibility, dimensional stability and toughness). It may also provide some basic ionic conductivity.

The function of rigid ionic conductive nanoparticles is to maximize their high ionic conductivity, due to the high surface area of the nanoparticles. Since these particles are rigid and crosslinked, it avoids excess swelling of the materials, which is often encountered by prior art polymers.

In another aspect, the present invention is directed to an electrode for use in fuel cells that includes:
1. An ionomer that consists or partially consists of the composite ionic conductive materials described above, which greatly enhance the compatibility of a Membrane Electrode Assembly (MEA) and strength of MEA bondage. The ionomer may comprise oxygen-facilitating groups, or carbon dioxide releasing promoter groups.
2. Electrode ink that comprises catalysts, ionomer and an appropriate solvent.

It is a second object of the invention to provide a cost effective method to process the ionic conductive materials into both electrode ink solution (as ionomer) and a membrane to form a membrane electrode assembly (MEA).

The ionic conductive materials may be in the form of polymers or in the form of monomers, being polymerized during the process of MEA formation.

It is a third object of present invention to provide a membrane electrode assembly (MEA) having internal water channels for self water regulation. One aspect of the invention is directed to MEAs having controlled hydrophobicity gradient. The unbalanced hydrophobicity between ionomers in the cathode and in the anode, forces water to flow from the cathode to the anode. It functions as “chemical pump” to move water from cathode to anode internally. It helps to reduce water flooding in the cathode, as well as supply necessary reactant towards the anode.

### BRIEF DESCRIPTION OF THE DRAWINGS

FIG. 1 is a schematic partial cross-section view of a membrane electrode assembly.

FIG. 2 illustrates the molecular structure of the ionic conductive material.

### DETAILED DESCRIPTION OF THE INVENTION

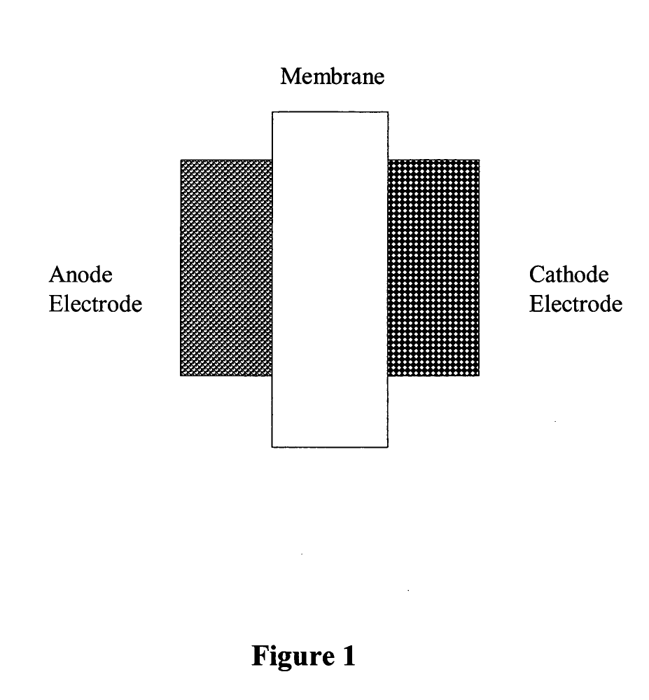

FIG. 1 schematically shows a partial cross-section view of a membrane electrode assembly (MEA) of the present invention used in a fuel cell. The MEA comprises a solid proton conducting polymer membrane, an anode and a cathode, where the cathode and anode are supported on the opposing surfaces of the membrane. Each electrode comprises dispersed catalyst materials and appropriated ionomers to form a catalyst layer in contact with each surface of the membrane.

At the anode, the hydrogen or methanol molecules react to form protons and electrons. In the case of methanol used as fuel, carbon dioxide is also formed. The electrons formed at the anode travel to the cathode through an external circuit, which produces electrical current to perform useful work by powering an electrical device. The protons migrate to the cathode through the membrane. At the cathode, oxygen molecules catalytically dissociate and react with the protons and the electrons from the anode to form water.

For a polymer electrolyte membrane fuel cell (PEMFC) using hydrogen as the fuel and oxygen as the oxidant, the reactions at the anode and cathode of the MEA are shown in equations below:
Anode: 2H₂→4H⁺+4e⁻ (I)
Cathode: 4e⁻+4H⁺+O₂→2H₂O (II)

The hydrogen can be supplied in the form of substantially pure hydrogen or as a hydrogen-containing reformate, for example, the product of the reformation of methanol and water or the product of the reformation of natural gas or of other liquid fuels. Similarly, the oxygen can be provided as substantially pure oxygen or the oxygen can be supplied from air at ambient or elevated pressure.

For a direct methanol fuel cell (DMFC) using methanol as the fuel and oxygen as the oxidant, the reactions at the anode and cathode of the MEA are shown in equations below:
Anode: CH₃OH+2H₂O→CO₂+6H⁺+6e⁻ (III)
Cathode: 6e⁻+6H⁺+3O₂→3H₂O (IV)

The oxygen can be provided as substantially pure oxygen or the oxygen can be supplied from air at ambient or elevated pressure

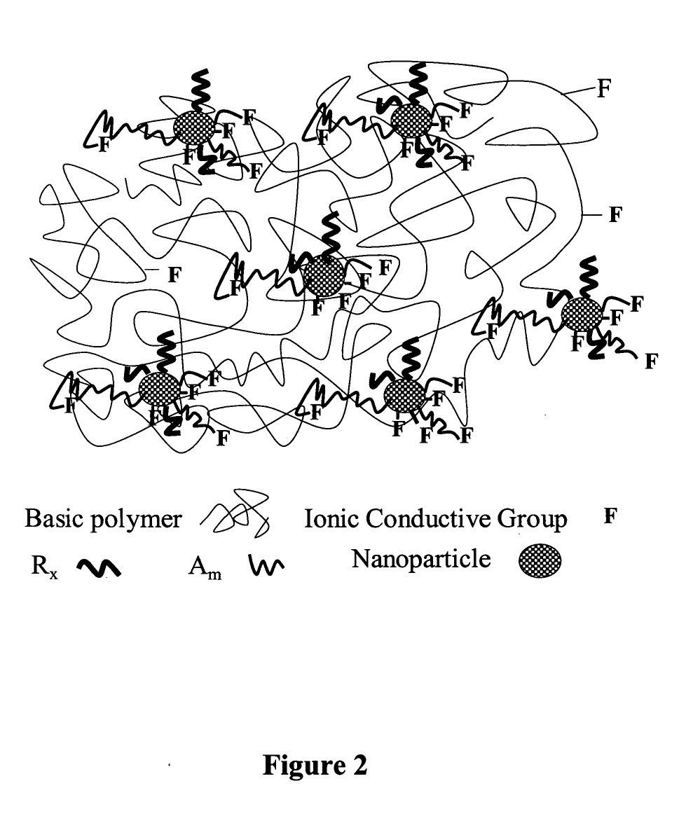

The ionic conductive materials of the present invention comprise a composite polymer matrix as shown in FIG. 2. The composite polymer matrix comprises base polymeric materials bearing ionic conductive groups (F), and ionic conductive nanoparticles well dispersed inside the base polymer via either physical or chemical bonds, preferably chemical bonds.

In one embodiment, the ionic conductive nanoparticles comprise a different length of molecular chains (Aₘ) where additional ionic conductive group (F) can be attached.

In other embodiment, the ionic conductive nanoparticles comprise molecular chains (Rₓ), which may be linked or crosslinked into a base polymer matrix or stand-alone for special functions, such as an oxygen facilitator or a carbon dioxide releasing promoter.

In a preferred embodiment, the ionic conductive nanoparticles offer a major ionic conductive boost mechanism. The nanoparticles are tightly bonded or crosslinked, and have hard-core and non-swelling characteristics. The hard-core nanoparticles prevent excess swelling, which has been often encountered by prior art polymers. The hard-core nanoparticles are preferably chemically linked to the base polymer matrix to avoid migration or clustering during operation for a stable performance.

The base polymers provide physical integrity and basic ionic conductive mechanism. The base polymers serve as a flexible matrix and offer good membrane formation characteristics, including mechanical strength, flexibility, toughness, chemical and thermal stability, and processablity.

The base polymers comprise vinyl polymer structure, such as polyethylene structure, polypropylene structure, polystyrene structure, poly(vinyl acetate) structure, polyacrylate structure, poly(vinyl chloride) structure, poly(vinyl fluoride) structure, poly(ethylene glycol) structure, Poly(ethylene oxide) structure, poly(propylene oxide) structure, polyacrylonitrile structure, polyisoprene structure, polyl1,2-butadiene structure, poly(ethylene amine) structure, and poly(acrylonitrile-butadiene-styrene) copolymer structure.

The base polymers may also comprise aryl polymer structure, such as poly(phenylene ether) structure, poly(naphthylene) structure, poly(phenylene) structure, poly(phenylene sulfide) structure, poly(ether ether ketone) structure, poly(ether ether sulfone) structure, poly(ether sulfone) structure, polysulfone structure, poly(ether ketone) structure, poly(imide) structure, polycarbonate structure, polybenzimidazol structure, polyoxadiazoles structure, and polytriazoles structure. Examples include poly(5-t-butylisophtalic oxadiazole) (TBI-POD), Poly(4′-(2′-diphenyl) hexafluoropropane oxadiazole) (HF-POD).

The base polymers may further comprise polymer structure containing silicone, such as polydiphenylsiloxane, diphenylsiloxane-dimethylsiloxane copolymer, diphenylsiloxae-dimethylsiloxane-trifluoropropylmethylsiloxane copolymer, poly(silsequioxane) family.

The base polymers may further comprise polymer structure of urethanes, epoxies and phenolic or copolymers of above. Example includes polyurethanes.

In addition, the base polymers may comprise a polymer structure bearing both ionic conductive groups and molecular side chains, which may be grafted into ionic conductive nanoparticles. Examples include trimethoxysilyl modified polyethylene and (triethoxysilyethyl ethylene-1,4-butadiene-styren) terpolymer.

Furthermore, the base polymers may comprise polymer chains containing other heteroatoms, such as P or N or both. Example includes the polyphosphazenes.

The basic polymers can comprise one of the above polymer structure, or two or more of above types of polymer structures, either on the main chain connection or side chain extension. The base polymers may also comprise a blend of the above type polymers. All of the base polymers may be fluorinated or partially fluorinated.

All of the base polymers contain ionic conductive groups (F), such as, but not limited to, sulfonic acid group (—SO₃H), phosphonic acid group (—PO₃H), carboxylic group (—COOH), and perfluorinated sulfoninc acid (—CF₂SO₃H) or combinations of these groups. The ionic conductive group can be attached to a main chain or side chain, if appropriate.

The density of the ionic conductive groups (F) for the base polymer should be minimum to avoid excess swelling. The density should not exceed 2.0 mmol./g, preferably from about 0 to 0.9 mmol./g.

Ionic conductive nanoparticles disperse into the polymer matrix via chemical and physical bonds, preferably chemical bonds.

The nanoparticles may comprise inorganic particles, preferably metal alkoxide families, more preferably selected from the group consisting of silicon alkoxide, aluminum alkoxide, zirconium alkoxide, and titanium alkoxide.

The nanoparticles may also comprise organic crosslinked beads, such as, but not limited to, crosslinked polystyrene, crosslinked polyethylene, crosslinked polypropylene, crosslinked polyolefin copolymers, crosslinked polyacrylates, crosslinked polyamide, crosslinked polyacetals, crosslinked polyethers, crosslinked polyphenylene sulfides, phenolics, epoxies, crosslinked polyesters, polyimide, polyurethanes, and crosslinked polybenziomdzaole. All of these polymers may be fluorinated or partially fluorinated.

In addition, the nanoparticles may comprise carbon nanotubes, C60-fullerene type or polyhedral oligomeric silsequioxane (POSS) types such as, but not limited to T8 cube.

The surface of the nanoparticles attach with numerous ionic conductive groups (F). The ionic conductive groups (F) can be bonded directly to nanoparticles or through molecular chains (Aₘ) as shown in FIG. 2. The density of the ionic conductive groups (F) should be from about 0.1 to 20 mmol./g, preferably from about 0.3 to 5.0 mmol./g, and most preferably from about 0.5 to 3.0 mmol./g.

Aₘ can be W-CnH₂ₙ, where m=0 to 20, preferably m=0 to 3; and n=0 to 30, preferably n=0 to 6. It may contain the same or different molecular chains among Aₘs. Ionic conductive groups (F) are connected to the ends of CₙH₂ₙ; while the other end of W is attached to nanoparticles.

W may contain an aromatic ring or other functional group such as an acrylate group, ether group, epoxy group, ethylene group, amide group or imide group. In another aspect, W may contain siloxanes group.

The surfaces of the nanoparticles may also contain molecular chains (Rₓ), which can be single linked or crosslinked to the base polymer matrix. Whereas x=1 to 10, preferably x=1 to 5; Each Rₓ may contain the same or different molecular chains. Rₓ may comprise molecular chains containing end groups of double bonds or other functional groups, such as acrylate, styrene, vinyl acetate, ethylene, propylene; or polysiloxane family with reactive functional groups, such as silanol, vinyl, hydride, amine, epoxy, carbinol, acrylate, mercapto, alkoxy; or a polyaryl ether family with a reactive end group, such as phenol, and halides. The length of molecular chain (Rₓ) can be varied from C0 to C20.

The functional end groups of Rₓ in the nanoparticles may be used as a reactive group to link or crosslink with the base polymer. The functional end groups may also be polymerized to form a base polymer backbone.

Rₓ may further be free end without links to base polymers. Rₓ may comprise a composition to promote hydrophobicity, oxygen facilitation and carbon dioxide removal. Examples include methacrylate T8 cube, or other functional POSS types. Examples also include special polysiloxane group and fluorinated carbon group, such as tri(trimethyl siloxy) silane.

The ionic conductive groups (F) for nanoparticles may be the same or different from that of base polymers. They may comprise, but are not limited to, sulfonic acid group (—SO₃H), phosphonic acid group (—PO₃H), carboxylic group (—COOH), and perfluorinated sulfonic acid (—CF₂SO₃H) or combinations of these groups.

The amount of ionic conductive nanoparticles may be from 0% to 99% by weight of the whole polymer membrane, preferably from about 10 to 50%, most preferably from about 20 to 40% by weight.

The above ionic conductive materials may be used to form film as a polymer electrolyte membrane. The above ionic conductive materials may also be used as ionomer and binder in the catalyst/electrode layer. An ionomer may comprise the same base polymer material and nanoparticles, but slightly different Aₘ and Rₓ groups for special requirement in the anode and cathode.

The above ionic conductive materials may be in the form of polymers, or in the form of pre-polymer to be polymerized or crosslinked during the MEA formation process.

The ionomers used in the cathode and anode electrode ink solutions may have same or different properties in this invention. In the preferred embodiment, ionomer in the anode may have less hydrophobicity than that of a polymer electrolyte membrane. Ionomer in the cathode may have more hydrophobicity than that of a polymer electrolyte membrane. The unbalanced hydrophobicity between anode and cathode creates an internal water channel to direct water flow from the cathode to the anode for self-water regulation. This yields a “chemical pump” to force water flowing from cathode to anode internally.

In one aspect, the ionomer in the cathode may comprise oxygen facilitator in Aₘ and Rₓ chains. Oxygen facilitator groups in the ionomer can improve oxygen transportation. High oxygen permeability in the cathode is critically important for a good performance of fuel cell. Examples of oxygen facilitators include silane oligomers, such as polydimethylsiloxane (PDMS), and trimethylsilane. Examples of oxygen facilitators also include perflourinated oligomers.

In another aspect, the ionomer in the anode may comprise a carbon dioxide releasing promoter in the Aₘ and Rₓ chains. In the case of methanol fuel cell operation, the byproduct of carbon dioxide from methanol oxidation can accumulate at the anode, resulting blockage of reactant. Promotion of carbon dioxide releasing will speed up the anode reaction rate. Examples of carbon dioxide releasing promoters include gas permeable materials such as polydimethylsiloxane (PDMS) and others polysiloxanes.

The ionic conductive materials can be processed into a membrane electrode assembly (MEA). In one embodiment, the process of making an MEA includes the steps of:
1. Making electrode ink solutions with a composition of (a) appropriate catalysts (b) solvent, (c) appropriate ionic conductive material as an ionomer for the cathode or anode;

The catalysts can be, but not limited to, platinum (Pt) on supported carbons for both cathode and anode in H₂ fuel cell application. In the case of methanol fuel cell applications, cathode catalysts comprise Platinum (Pt) and anode catalysts comprise Platinum/Ruthenium (Pt/Ru), as well as other catalyst materials.

Particular examples of the solvent may include, but not limited to, non-proton polar solvent such as dimethlacetoamide, dimethyl formamide, N-methyl-2-pyrrolidone, dimethyl sulfoxide, dimethylurea and the like. Examples may also include alcohol solvent such as methanol, ethanol, n-propyl alcohol, iso-propyl alcohol, 1-methoxy-2-propanol and the like. Solvents can also include toluene and tetrahydrofuran (THF). These solvents can be also used as a mixture.

The ionomers used in the cathode and anode electrode ink solutions may have different properties in this invention. In the preferred embodiment, the ionomer in the anode may have less hydrophobicity than that of the polymer electrolyte membrane. The ionomer in the cathode may have more hydrophobicity than that of the polymer electrolyte membrane.

In one aspect, the ionomer in the cathode may comprise an oxygen facilitator. In another aspect, the ionomer in the anode may comprise a carbon dioxide releasing promoter.

The ionomer can be in the range of about 1% to 60% of catalyst by weight, preferably about 5% to 30% by weight. The solid content of the electrode ink solution (catalyst+ionomer) can range from about 1% to 99% by weight, preferably from about 5% to 30% by weight.
2. Applying an electrode ink solution onto a surface of a substrate, and spreading to form a substantially uniform layer, via a coating method, such as a solution casting, spraying or printing method;

The thickness of the layer ranges from about 0.1 μm to 200 μm.

The catalyst loading ranges from about 0.01 mg/cm² to 20 mg/cm².

The substrate may be polyethylene terephthalate (PET) film, polyimide film, polyethylene film, polypropylene film, or any materials used as a substrate for the solution casting method or printing method, for example, plastic materials and metal materials.
3. Semi-Curing the electrode layer under thermal or UV exposure

The temperature ranges from about 25° C. to 200° C., preferably about 50 to 150° C., for a period of time of from about 1 min. to 48 hours, preferably about 5 to 120 minutes. UV exposure time ranges from about 1 sec. to 10 min., preferably about 0.1 min. to 2 min.
4. Making a polymer electrolyte solution with a composition of (1) the ionic conductive material, and (2) solvent;

Particular examples of the solvent may include, but not limited to, non-proton polar solvent such as dimethlacetoamide, dimethyl formamide, N-methyl-2-pyrrolidone, dimethyl sulfoxide, dimethylurea and the like. Examples may also include alcohol solvent such as methanol, ethanol, n-propyalcohol, iso-propyl alcohol, 1-methoxy-2-propanol and the like. Solvents can also include toluene and tetrahydrofuran (THF). These solvents can also be used as a mixture.

The ionic conductive materials may be in the form of polymers, or in the form of pre-polymer to be polymerized or crosslinked during the MEA formation process.

The solid content of electrolyte solution (ionic conductive material) can be from 1% to 99% by weight, preferably from 5% to 30% by weight.
5. Applying the polymer electrolyte solution over a semi cured electrode layer via a coating method, such as a solution casting, spraying, or printing method.

The thickness of the electrolyte layer ranges from about 1 μm to 300 μm, preferably about 10 to 100 μm.
6. Exposing to thermal or UV source for semi-curing.

The temperature ranges from about 25° C. to 200° C., preferably about 50 to 150° C., for a period of time of from about 1 min. to 48 hours, preferably about 5 to 120 minutes, or UV exposure time from about 1 sec. to 10 min., preferably about 0.1 min. to 2 min.
7. Applying the other electrode ink solution over the top of the electrolyte layer, and spreading a substantially uniform layer via a coating method, such as a solution casting, spraying, or printing method.

The thickness of the layer ranges from about 0.1 μm to 200 μm.

The catalyst loading ranges from about 0.01 mg/cm² to 20 mg/cm²
8. Passing through thermal or UV radiation for final cure.

The temperature ranges from about 10° C. to 200° C., preferably about 25° C. to 150° C., for a period of time of from about 1 min. to 48 hours, preferably about 5 to 120 minutes. UV exposure time ranges from about 1 sec. to 10 min., preferably about 0.1 min. to 2 min.

The resulting MEA can be used for PEM fuel cell applications, especially DMFC. It was tested in a direct methanol fuel cell environment, and showed good conductivity, low crossover, high power density, and self-water regulation.

The ionic conductive materials of the present invention can be also used for battery electrolytes and the like; ion exchange membranes, such as electrolysis, desalination and the like; various sensors, such as humidity sensor, gas sensor and the like; liquid and gas separators and the like.

### EXAMPLE 1

0.78 g of trimethoxysilyl modified polyethylene (Gelest Inc.) was dissolved in 47.89 g of toluene at a temperature of 80° C. 1.12 g of TEOS and 1.62 g of de-ion water were added into the above solution, and the solution was under flux for 3 hours. After cooling down to room temperature, 4.07 g of 2-(4-chlorosulfonylphenyl) ethyltrichlorosilane, 50% by wt. in toluene (Gelest inc.) was added into the above solution. The mixture solution was then stirred at a temperature of 80° C. for 4 hrs. The solution was poured into an aluminum pan. After drying at 50° C. oven for 4 hours, a semi-transparent film was formed with thickness around 1 mil. The film had good physical strength and flexibility. The ionic conductivity of the film was 0.025 s/cm.

### EXAMPLE 2

0.23 g of trimethoxysilyl modified polyethylene (SSP50, Gelest Inc.) was dissolved in a mixture of solvents (20.36 g of toluene and 21 g of THF) at a temperature of 80° C. After stirring 1 hour, 7.5 g of polytriethoxysilyethylene-1,4-butadiene-styrene terpolymer, 50% by wt. in toluene (SSP225, Gelest Inc.) and 5.85 g of THF were added to the above solution.

After stirring 0.5 hour at a temperature of 80° C., 9.70 g of the above solution was mixed with 1.67 g of 2-(4-chlorosulfonylphenyl) ethyltrichlorosilane, 50% by wt. in toluene (Gelest Inc.). The mixture solution was stirred at a temperature of 80° C. for 5 minutes. The solution was poured into a glass plate well. After drying at 50° C. in an oven for 20 min., and then room temperature for 12 hours, a nice transparent film was formed with thickness of about 1.5 mil. The film had good physical strength and flexibility. The ionic conductivity of the film was 0.043 s/cm. The swelling of the film in 8 molar methanol aqueous solution at 80° C. was 27% by area.

### EXAMPLE 3

0.23 g of trimethoxysilyl modified polyethylene (SSP50, Gelest Inc.) was dissolved in a mixture of solvents (20.15 g of toluene and 20.53 g of THF) at a temperature of 80° C. After stirring 1 hour, 2.25 g of the above solution was mixed with 0.41 g of polytriethoxysilyethylene-1,4-butadiene-styrene terpolymer, 50% by wt. in toluene (SSP225, Gelest Inc.), 0.82 g of MPA, 0.45 g of THF, 0.15 g of U1P solution (8.5% of EBIS (trimethoxysilyl) Propyl modified polyurethane, GE), and 0.57 g of 2-(4-chlorosulfonylphenyl) ethyltrichlorosilane, 50% by wt. in toluene (Gelest Inc.). The mixture solution was stirred at a temperature of 70° C. for 5 minutes. The solution was poured into a glass plate well. After drying at 70° C. in an oven for 20 min. and then room temperature 12 hours, a nice transparent film was formed with thickness of about 1.0 mil. The film had a good physical strength and flexibility. The ionic conductivity of the film was 0.060 s/cm. The swelling of the film in 8 molar methanol aqueous solution at 80° C. was 17% by area.

### EXAMPLE 4

1 g of cross linked Styrene-DVB latex beads (200 nm in size, Bangs Lab Inc.) was placed in 50% H₂SO₄ solution at 60° C. for 24 hrs. The sulfonated beads were filtered out, washed with di-ion water, and dried in air for 24 hrs. The beads (0.1 g) were mixed into 1 g of styrene monomer (Aldrich Inc.). AIBN Initiator (Aldrich Inc.) was added and fluxed for 3 hrs. The final solution was poured into a Petri dish, and cured under UV (Fusion UV inc) for 2 min. A translucent film was obtained with a thickness of 2 mil. The film had good physical strength and flexibility. The ionic conductivity of the film was 0.003 s/cm.

### EXAMPLE 5

Ionomer solution was prepared with mixing 2.25 g of trimethoxysilyl modified polyethylene (SSP50, Gelest Inc.) solution (0.5% by wt in Toluene), 0.51 g of Toluene, 0.42 g of polytriethoxysilyethylene-1,4-butadiene-styrene terpolymer, 50% by wt. in toluene (SSP225, Gelest Inc.), 0.25 g of U1P solution (8.5% of EBIS (trimethoxysilyl) Propyl modified polyurethane, GE inc.), and 1.02 g of 2-(4-chlorosulfonylphenyl) ethyltrichlorosilane, 50% by wt. in toluene (Gelest Inc.).

Anode ink solution was prepared by mixing 0.30 g of above ionomer solution, 0.13 g of Pt/Ru black (E-Tek Inc.), and 0.30 g of iso-propyl alcohol (IPA).

Cathode ink solution was prepared by mixing 0.30 g of above ionomer solution, 0.14 g of 20% wt. Pt/C (E-Tek Inc.), and 0.60 g of IPA.

Electrolyte solution was prepared as described in Example 2.

MEA preparation: the above cathode ink solution was applied onto a glass plate with the right size of mask using a doctor knife with setting 40. After drying in air for 1 hour, the above electrolyte solution was coated over the cathode catalyst layer using doctor knife with setting 50. The above anode ink solution was then coated over the above bi-layers with the right size of mask after it dried in air for 1 hour. The MEA was further dried in air for 12 hours prior to being soaked in water for washing and hydration in an 80° C. oven for 24 hours.

The hydrated MEA was placed in a methanol fuel cell testing apparatus. The performance was equivalent to the MEA based on Nafion with similar catalyst loading.

Having thus described the invention, I claim:

1. An ionic conductive material comprising 1) a base polymer containing: ionic conducting groups, said polymer having flexible and strong molecular chains, and 2) rigid, conductive nanoparticles disbursed among the base polymer.

2. The ionic conductive material of claim 1 in which the ionic charge density of the ionic conducting groups in the flexible base polymer is from about 0 to 2.0 mmol/gram.

3. The ionic conductive material of claim 1 in which the ionic charge density of the rigid, ionic conductive nanoparticles is from about 0 to 10 mmol/gram.

4. The ionic conductive material of claim 1 in which the base polymer comprises a vinyl polymer, an aryl polymer or a polyurethane.

5. The ionic conductive material of claim 1 in which the base polymer also comprises silicone, and other heteroatoms, such as P or N or both.

6. The ionic conductive material of claim 1 in which the base polymers can be fluorinated, partially fluorinated or non-fluorinated.

7. The ionic conductive material of claim 1 in which the base polymer also comprises ionic conductive groups and molecular side chains.

8. The ionic conductive material of claim 7 wherein the conductive groups comprise sulfonic acid groups, phosphonic acid groups, carboxylic groups or perfluorinated sulfonic acid groups or combinations of these groups.

9. The ionic conductive material of claim 7 wherein the molecular side chains comprise hydrophobic groups, oxygen facilitating groups, or CO₂ releasing promotion groups.

10. The ionic conductive material of claim 1 in which the rigid nanoparticles comprise inorganic particles, organic crosslinked beads, POSS structures or carbon nanotubes.

11. The ionic conductive material of claim 1 in which the rigid nanoparticles also comprise ionic conducting groups and molecular side chains.

12. The ionic conductive material of claim 11 wherein the ionic conducting groups comprise sulfonic acid groups, phosphonic acid groups, carboxylic groups or perfluorinated sulfonic acid groups or combinations of these groups.

13. The ionic conductive material of claim 11 wherein the molecular side chains comprise hydrophobic groups, oxygen facilitating groups, or CO₂ releasing promotion groups.

14. The ionic conductive material of claim 1 in which the rigid nanoparticles are physically and chemically linked to the base polymer.

15. The ionic conductive material of claim 1 in which the base polymer is in the form of a pre-polymer, to be polymerized or crosslinked during a membrane electrolyte assembly formation process.

16. A membrane electrolyte assembly used in polymer electrolyte membrane fuel cell, comprising a polymer electrolyte membrane, an anode, a cathode, the anode and the cathode being on opposing surfaces of the membrane, and a catalyst layer in contact with each surface of the membrane.

17. The membrane electrolyte assembly of claim 16 in which the polymer electrolyte membrane comprises the ionic conductive material of claim 1.

18. The membrane electrolyte assembly of claim 16 in which the anode and cathode comprise ionomers comprising the ionic conductive material of claim 1.

19. The membrane electrolyte assembly of claim 16 in which the hydrophobicity of the cathode is stronger than that in the polymer electrolyte membrane and the hydrophobicity of the anode is weaker than that in the polymer electrolyte membrane.

20. The membrane electrolyte assembly of claim 16 in which the hydrophobicity of the ionomer in cathode is stronger than that in the polymer electrolyte membrane and the hydrophobicity of the ionomer in anode is weaker than that in the polymer electrolyte membrane.

21. The membrane electrolyte assembly of claim 16 in which the cathode ionomer comprises an oxygen facilitator group and the anode ionomer comprises a carbon releasing promoter.

22. A method for making a membrane electrode assembly comprising:
a. making an anode electrode ink solution comprising (1) an anode catalyst (2) a solvent, (3) an ionomer for an anode, and making a cathode electrode ink solution comprising (1) a cathode catalyst (2) a solvent, and (3) an ionomer for a cathode;
b. applying the anode electrode ink solution of step (a) onto a surface of a substrate, and spreading the solution to form a substantially uniform anode electrode layer via a coating method;
c. semi-curing the anode electrode layer of step (b) using thermal or UV exposure;
d. making a polymer electrolyte solution comprising (1) the ionic conductive material of claim 1, and (2) a solvent;
e. applying the polymer electrolyte solution of step (d) over a semi-cured electrode layer of step (c), and spreading to form a substantially uniform electrolyte layer via a coating method;
f. exposing the electrolyte layer of step (e) to a thermal or UV source for semi-curing;
g. applying the cathode electrode ink solution of step (a) over the top of the electrolyte layer of step (f), and spreading to form a substantially uniform cathode electrode layer via a coating method;
h. passing the cathode electrode layer of step (g) through thermal or UV radiation for a final cure.

23. The method of claim 22 in which the catalyst is Pt for the cathode and Pt/Ru for the anode, for a direct methanol fuel cell.

24. The method of claim 22 in which the catalyst is Pt/C for the cathode and Pt/C for the anode, for a H₂ fuel cell.

25. The method of claim 22 in which the ionomer of step (a) comprises the ionic conductive materials of claim 1.

26. The method of claim 22 in which the polymer electrolyte solution of step (d) comprises the ionic conductive materials of claim 15.

27. The method of claim 22 in which the electrolyte layer of step (f) ranges from about 1 μm to 500 μm in thickness.

28. A method for making a membrane electrode assembly comprising:
a. making an anode electrode ink solution comprising (1) an anode catalyst (2) a solvent, (3) an ionomer for an anode, and making a cathode electrode ink solution comprising (1) a cathode catalyst (2) a solvent, and (3) an ionomer for a cathode;
b. applying the cathode electrode ink solution of step (a) onto a surface of a substrate, and spreading the solution to form a substantially uniform cathode electrode layer via a coating method;
c. semi-curing the cathode electrode layer of step (b) using thermal or UV exposure;
d. making a polymer electrolyte solution comprising (1) the ionic conductive material of claim 1, and (2) a solvent;
e. applying the polymer electrolyte solution of step (d) over a semi-cured electrode layer of step (c), and spreading to form a substantially uniform electrolyte layer via a coating method;
f. exposing the electrolyte layer of step (e) to a thermal or UV source for semi-curing;
g. applying the anode electrode ink solution of step (a) over top of the electrolyte layer of step (f), and spreading to form a substantially uniform anode electrode layer via a coating method;
h. passing the anode electrode layer of step (g) through thermal or UV radiation for a final cure.

29. The method of claim 28 in which the catalyst is Pt for the cathode and Pt/Ru for the anode, for a direct methanol fuel cell.

30. The method of claim 28 in which the catalyst is Pt/C for the cathode and Pt/C for the anode, for a H₂ fuel cell.

31. The method of claim 28 in which the ionomer of step (a) comprises the ionic conductive materials of claim 1.

32. The method of claim 28 in which the polymer electrolyte solution of step (d) comprises the ionic conductive materials of claim 15.

33. The method of claim 28 in which the electrolyte layer of step (f) ranges from about 1 μm to 500 μm in thickness.

34. The method of claim 22 in which the coating method is a solution casting, spraying or printing method.

35. The method of claim 28 in which the coating method is a solution casting, spraying or printing method.
